(19) United States
(12) Patent Application Publication
(10) Pub. No.: US 2003/0218847 A1
(43) Pub. Date: Nov. 27, 2003

(54) Solid state relay/circuit breaker system

(75) Inventors: Alan C. Lesesky, Charlotte, NC (US); Bobby Ray Weant, Rock Hill, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Vehicle Enhancement Systems, Inc.

(21) Appl. No.: 10/352,785

(22) Filed: Jan. 28, 2003

Related U.S. Application Data
(60) Provisional application No. 60/352,357, filed on Jan. 28, 2002.

(51) Int. Cl. H02H 3/00

(52) U.S. Cl. 361/100

(57) ABSTRACT

The relay system of the present invention comprises a field effect device such as a MOSFET and a microprocessor that controls the on and off states of the field effect transistor. The processor monitors the current supplied to the field effect device and open circuits the device if the current exceeds a selected value. Importantly, the present invention uses a field effect device and microprocessor, as opposed to contacts, a coil and a downstream circuit breaker like conventional electromechanical relays. Unlike an electromechanical relay, the solid state relay is free of problems that arise from having mechanical parts. The solid state relay fuse is free of arcing, sparking, and there are no contact materials that can wear out or generate noise. Because of the use of a microprocessor, the solid state relay has a faster switching speed, and there are no switching voltage spikes from turning on a coil.

### CROSS-REFERENCE TO RELATED APPLICATIONS

The present application claims priority from U.S. Provisional Application Serial No. 60/352,357 entitled SOLID STATE RELAY/CIRCUIT BREAKER SYSTEM, filed Jan. 28, 2002, the contents of which are incorporated herein by reference.

### BACKGROUND OF THE INVENTION

1. Field of the Invention

The present invention relates in general to circuit breaker systems and in particular to circuit breaker systems that include solid-state relays.

2. Description of Related Art.

For years, electromechanical relays have been used in a wide-variety of electrical applications. FIG. 1 is an illustration of a typical electromechanical relay. This figure illustrates the mechanical coil, 1 and 2, a relay 3, and fuse 6. The relay is connected to alternative loads 4 and 5. These mechanical devices, which are built of a coil and contacts, have demonstrated considerable reliability. Despite this reliability, mechanical relays still suffer from problems associated with having moving parts. Mechanical relays are subject to arcing and sparking. The switching of the coil can lead to voltage spikes, or fly-back voltage. Material fatigue can shorten the life of the mechanical relay. Further, the contact materials in mechanical relays result in operating noise and eventual contact erosion. Reliable operation of a mechanical relay can be lost if it is subjected to shock and vibration.

These types of mechanical issues can be major concerns where the relay is used in harsh environments. For example, many vehicles, such as cars and tractor/trailers, include a wide variety or relays in their electrical systems. These relays are subjected to constant vibrations introduced from operation of the vehicles. Further, many of the relays are exposed to environmental elements that can lead to corrosion.

In addition to mechanical problems, current day, electromechanical relays utilize a downstream circuit breaker, as opposed to an internal circuit breaker. Two common circuit breakers are Type I circuit breakers and Type II circuit breakers. These types of circuit breakers are thermal circuit breakers. After a Type I circuit breaker is opened, it recycles every fifteen (15) seconds to see if the load that opened it is still present. If the load is gone, it resets itself. If the load is still present, the Type I circuit breaker will remain in the opened position. Type II circuit breakers, after they are opened by an over-current, can be reset by simply turning power off and then back on to reset them.

One problem with Type I and Type II circuit breakers is that they are not solidstate devices. They instead, are mechanical. A thermal circuit breakers current limit is determined at an ambient temperature of 25 degrees Celsius or 77 degrees Fahrenheit. When a thermal circuit breaker is exposed to heat, similar to summer time temperatures, the current trip point decreases at an increasing rate based on temperature. Alternatively, when a thermal circuit breaker is exposed to the cold of winter, the current limit can increase up to as much as two times it's 25 degrees Celsius rating.

These variations in performance are of major concern where the breakers are used in applications in which the breakers may experience either extreme conditions or rapid changes in temperature. For example, if the breakers are used in vehicles, such as cars or tractor/trailers, the breakers may be subjected to extreme heat and cold, as well as rapid transitions between hot and cold temperatures.

### BRIEF SUMMARY OF THE INVENTION

The present invention remedies many of the problems associated with mechanical relays by providing a solid state relay/circuit breaker system. The improved relay system is composed of a field effect device such as a MOSFET. Connected to the MOSFET is a microprocessor that controls the on and off states of the field effect transistor. Specifically, the processor monitors the current supplied to the field effect device and open circuits the device if the current exceeds a selected value. Importantly, the present invention uses a field effect device and microprocessor, as opposed to contacts, a coil and a downstream circuit breaker like conventional electromechanical relays. Unlike an electromechanical relay, this electronic or solid state relay is free of problems that arise from having mechanical parts. The solid state relay fuse is free of arcing, sparking, and there are no contact materials that can wear out or generate noise. Because of the use of a microprocessor, the solid state relay has a faster switching speed, and there are no switching voltage spikes from turning on a coil. Without moving parts that are subject to material fatigue, this solid state relay has a longer operating life, and is more reliable. Further, by using a microprocessor, the solid state relay is resistant to shock and vibration.

The relay of the present invention is configured to be used with conventional packaging systems. Specifically, the device can be housed in relay packages having conventional footprints such as housing having ISO or 150 series footprints. Further, the relay may be housed on a circuit board having a connector for installation in conventional systems. The relays may be configured for installation in conventional power distribution systems.

Importantly, the microprocessor used to control the relay may various functions. Specifically, it can receive inputs from other devices such as toggle switches. Based on the inputs, the microprocessor controls the relay to either open or close. Further, the microprocessor may be used as a multiplexer, where several relays are connected to output pins of a common processor such that the processor can selectively configure a plurality of relays based on input commands.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a prior art illustration of a relay system;

FIG. 2 is solid state relay device according to one embodiment of the present invention, wherein the relay is packaged in a single housing according to one embodiment of the present invention;

FIG. 3 is a schematic diagram of a solid state relay according to one embodiment of the present invention;

FIG. 4 illustrates a packaging system for enclosing a solid state relay according to one embodiment of the present invention;

FIG. 5 illustrates a packaging system having an ISO footprint for enclosing a solid state relay according to one embodiment of the present invention;

FIG. 6 illustrates a packaging system having a 150 series footprint for enclosing a solid state relay according to one embodiment of the present invention;

FIG. 7 illustrates a relay device according to one embodiment of the present invention where a microprocessor is used to control a mechanical relay having a conventional breaker;

FIG. 8 illustrates a relay device according to one embodiment of the present invention where a microprocessor is used to control a mechanical relay having an over-current circuit;

FIGS. 9A-9C illustrate a relay device according to alternative embodiments of the present invention housed in a conventional power distribution center.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The present invention remedies many of the problems associated with mechanical relays by providing a solid state relay/circuit breaker system. As illustrated in FIG. 2, this improved relay system is composed of a field effect device 8 such as a MOSFET. Connected to the MOSFET is a microprocessor 7 that controls the on and off states of the field effect transistor. Specifically, the processor monitors the current supplied to the field effect device and open circuits the device if the current exceeds a selected value. In some embodiments, the present invention may further include a thermistor 9 that measures the temperature surrounding the device. This temperature is used by the processor, which compensates the current reading for the temperature reading using a stored look-up table.

Importantly, the present invention uses a field effect device and microprocessor, as opposed to contacts, a coil and a downstream circuit breaker like conventional electromechanical relays. Unlike an electromechanical relay, this electronic or solid state relay is free of problems that arise from having mechanical parts. The solid state relay fuse is free of arcing, sparking, and there are no contact materials that can wear out or generate noise. Because of the use of a microprocessor, the solid state relay has a faster switching speed, and there are no switching voltage spikes from turning on a coil. Without moving parts that are subject to material fatigue, this solid state relay has a longer operating life, and is more reliable. Further, by using a microprocessor, the solid state relay is resistant to shock and vibration.

The solid state relay of the present invention is also accompanied by its own internal circuit breaker, as opposed to the external breaker used in conventional systems. This reduces the number of connections that must be made in the system and also makes replacement easier.

Importantly, because the relay of the present invention includes a microprocessor, the relay is very flexible, as it can be programmed to perform several different functions. For example, the relay of the present invention can be used in some of the following applications, to name a few:

1) A blinker, flasher, etc.

2) Time delay

3) Self Test

4) Any other functions by changing program

As mentioned above, conventional external circuit breakers used in many conventional electromechanical relays are generally affected by temperature changes. However, the internal circuit breaker of the present invention has a significantly reduced variation in operation over the typical range of operating temperatures. Another advantage to having an internal circuit breaker in this relay is saved space. Having an internal circuit breaker omits the need to add an external circuit breaker or fuse to an existing circuit. The internal circuit breaker is solid state and programmable for different trip currents and time delays. This solid state relay with built-in circuit breaker ensures a constant current limit, fast switching speed and high reliability despite changes in temperature and other conditions.

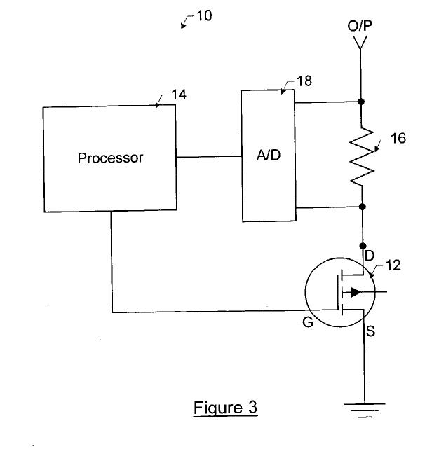

As mentioned the relay of the present invention replaces the mechanical coil and relay of conventional electromagnetic relays with a microprocessor and MOSFET or other similar field-effect transistor. FIG. 3 illustrates a schematic representing one embodiment of the present invention. In this embodiment, the relay/circuit breaker 10 of the present invention includes a MOSFET 12 and microprocessor 14. The microprocessor is connected to the gate G of the MOSFET, and the source S of the MOSFET is connected to ground. An over-current circuit having a resistor 16 is connected between the drain D of the MOSFET and the output O/P. Importantly, the over-current circuit also includes an analog to digital (AID) converter 18 connected across the resistor. In operation, the microprocessor controls the MOSFET and observes over-currents by monitoring the voltage across the resistor provided by the AID converter.

FIG. 3 illustrates only one example of the present invention. For example, there are currently available MOSFETs and other filed-effect transistors that include internal over-current and over-temperature circuits. These internal circuits regulate operation of the FETs based on their current and temperature. When these FETs are used, the resistor and A/D are not required.

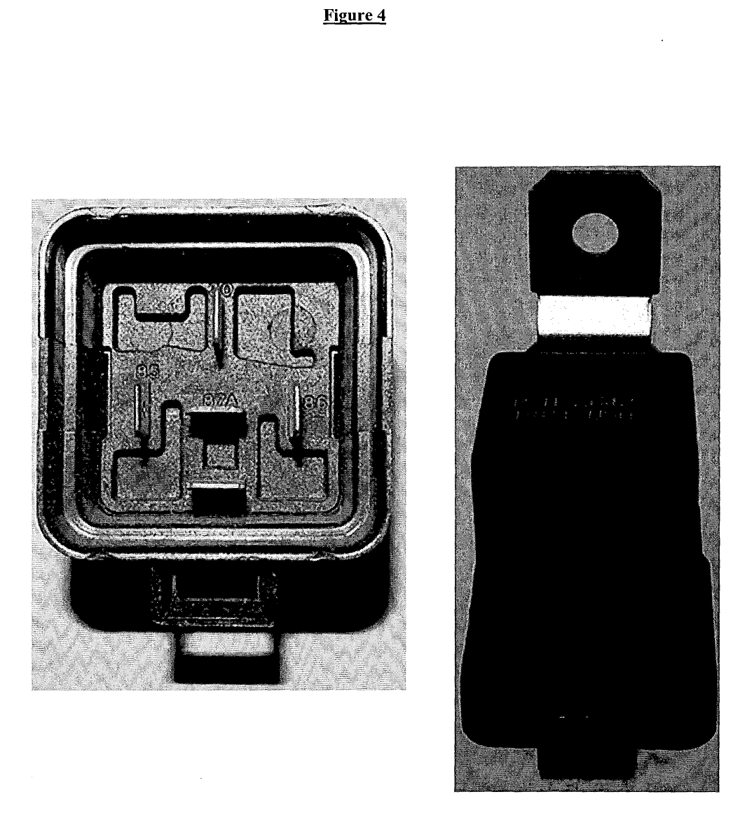

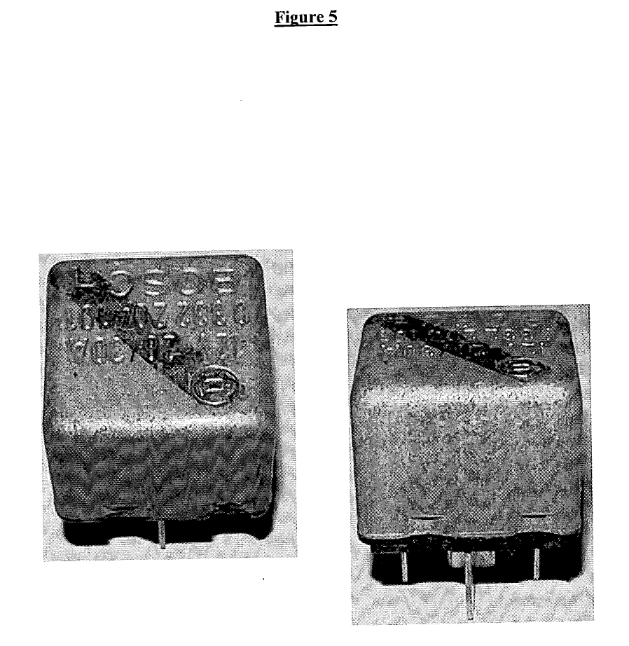

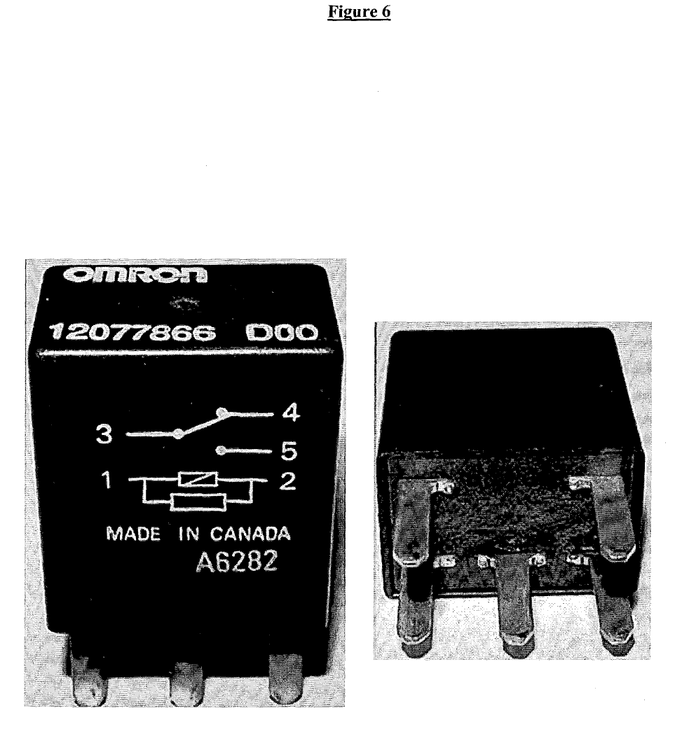

Another important aspect of the present invention is the use of currently available packaging for the relay/circuit breaker of the present invention. This allows the relay/circuit breaker to be used as a retrofit in existing electrical systems. For example, FIG. 4 illustrates packaging for the relay/circuit breaker of the present invention according to one embodiment. Further, FIGS. 5 and 6 illustrate packages for ISO and 150 series footprints. In these embodiments, the field effect transistor and processor are placed on a circuit board. The circuit board is then housed in the existing packaging with connections from the circuit board to the footprint leads resident in the package.

It must be understood that these are mere examples of the packaging, and that the present invention should not limited to these examples.

As mentioned above, the conventional electromagnetic relay system does not include both the relay and the circuit breaker in one package. Specifically, the relay is typically one unit and the circuit breaker is separate, and they are connected by wiring. This requires different connections for the relay and the circuit breaker, as well as additional wiring. In light of this problem, the present invention also provides mechanical relay systems that include both the conventional mechanical relay and the conventional mechanical circuit breaker in one package. For example, in this embodiment, both the mechanical relay and the circuit breaker can be housed in a package having an ISO or 150 series footprint, such as those respectively illustrated in FIGS. 5 and 6. This embodiment of the present invention advantageously allows mechanical relay and circuit breakers to reside in one package, requiring only one standard connection point.

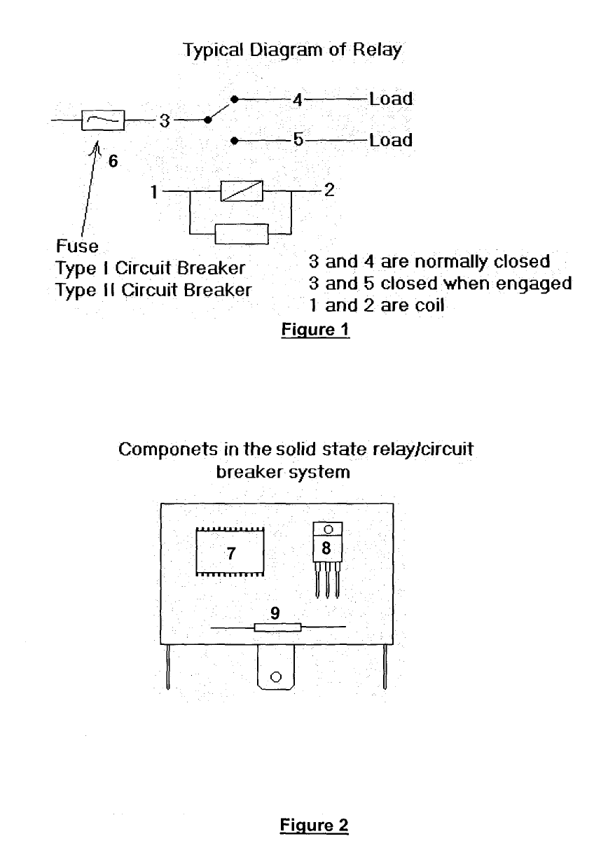

As mentioned above, the present invention provides a processor for controlling the action of the MOSFET relay. It must be understood that in some embodiments, the processor of the present invention may also be used with electromechanical relays, such as the one generally illustrated in FIG. 1. An example of this embodiment is illustrated in FIG. 7. In this embodiment, a processor is connected to the coils of the mechanical relay and controls the mechanical relay based on commands stored in the processor. As such, an electromechanical relay can be programmed to perform specialized functions by storing different control programs in the processor.

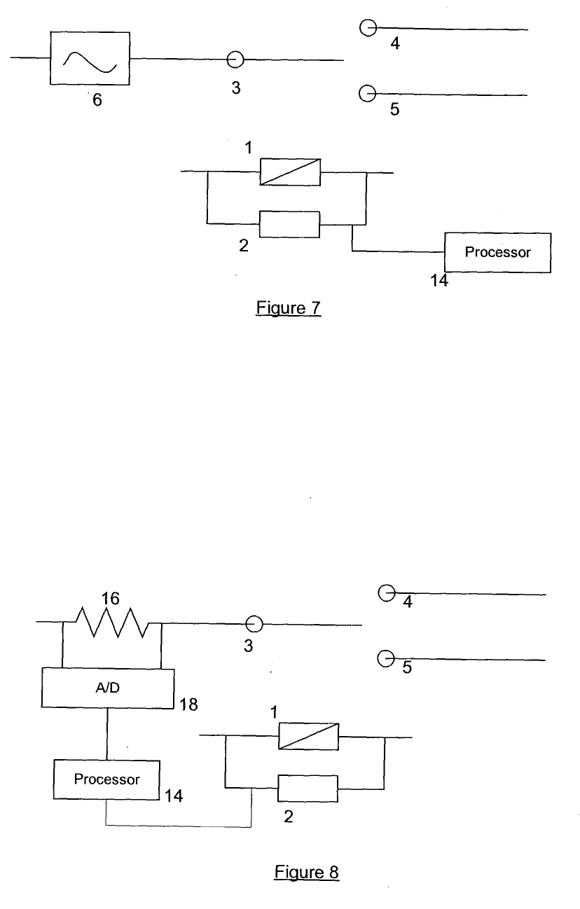

Further, the present invention may include other relay systems that are a combination of both solid state and mechanical device. For example, the present invention may include systems having a mechanical relay, but uses a solid state circuit breaker, such as a processor, A/D, and resistor for measuring current through the relay. This is illustrated in FIG. 8. Similarly, the relay system of the present invention could include a MOSFET as a relay and a Type I, Type II, or other type of mechanical circuit breaker.

As discussed in the above embodiments, the relay system of the present invention uses a microprocessor in combination with either a mechanical relay or a solid state relate. The microprocessor controls the actuation of the relay. The microprocessor can be used for other functions other than just sensing an over-current. Specifically, the microprocessor can be programmed to operate the relays based on remote commands. For example, the microprocessor could be connected to a remote switch or similar device. The switch could be used to indicate when the relay associated with the microprocessor should be opened or closed. For example, the relay could control the lights on a vehicle and the switch could located in the cockpit of the vehicle to indicate when the lights should be turned to the on position. In this instance, when the switch is flipped, the processor senses this change in the switch and, in turn, configures the relay appropriately.

In one example, the device could be located in a tractor/trailer where a data bus is used to communicate between a switch located in the cab of the truck and relay located elsewhere on the truck or trailer. In this instance, the switch would be connected to the microprocessor via the data bus, and the microprocessor would be configured to use the When the switch is flipped, a signal is sent over the data bus to the processor, which in turn, controls the relay. In a tractor/trailer combination, the data bus may use a data protocol such as J1708 or J1939. In this instance, the microprocessor would include circuitry and/or software to translate the protocol.

FIGS. 5 and 6 illustrate the relay of the present invention housed in a conventional relay package. There are other ways that the relay could be package, however. For example, the relay could be located on a circuit board having connector pins for connection in a relay socket or other system. In this regard, in one embodiment, the relay of the present invention is housed in a commercial packaging such as that described in U.S. Pat. No. 5,587,890 to Happ et al., which is incorporated by reference in entirety herein.

Specifically, the '890 Happ patent describes an electronic power distribution center having multiple circuit board layers for forming various connections between electronic devices, such as relays, with other devices or circuits. The distribution center includes a standard connector system that allows devices to be inserted in the connectors for making connections. For example, this connector system is configured to accept standard housing footprints, such as for example conventional ISO and 150 series packages. In this distribution system, the relay of the present invention may be housed in an ISO or 150 series package such as those illustrated in FIGS. 5 and 6 or the relay may be included on a circuit board having a connector designed to mate with the connector of the distribution system described in the '890 Happ patent.

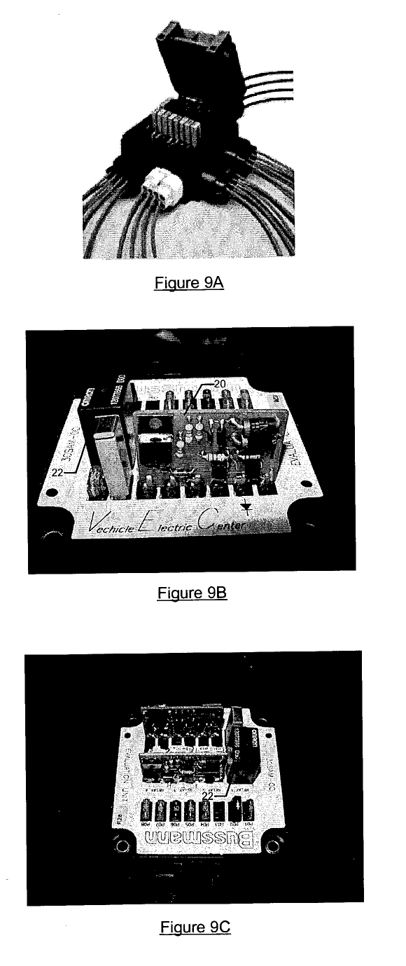

For example, FIGS. 9A-9C illustrate an electronic distribution center as disclosed in the '890 Happ patent. As illustrated in FIGS. 9B and 9C, the relay device 10 of the present invention may take either the form of a PC board 20 of a standard relay package 22.

As mentioned above, the microprocessor of the relay system of the present invention may also be used to accept controls inputs from a remote location for configuring the relay. Where the relay device is used in conjunction with a power distribution center such as that disclosed in the '890 Happ patent, the relay may be used as a multiplexing device. Specifically, various relays could be connected to the distribution center, where each is connected to a separate output pin of a common microprocessor, such that the microprocessor can individually control each relay based output to designated pins. In this embodiment, the microprocessor acts as a central control device for controlling various relays connected thereto. Further, the microprocessor may also be considered a multiplexer in this context in that it can receive inputs from various control switches and selectively configure different relays based on these control inputs. For example, a common microprocessor may be connected to two separate relays via the power distribution center. One relay may control trailer lighting, while another relay controls tractor lighting. Located in the cab of the tractor and connected to the microprocessor are switches for controlling the lighting. If the trailer switch is flipped to an on position, the microprocessor will control the trailer relay to close to provide trailer lighting and will similarly close the relay related to cab lighting if the cab lighting switch is closed.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A relay for use in an electrical system comprising:
a field-effect transistor having an output; and
a processor connected to said field-effect transistor, wherein said processor controls whether the relay appears as a closed or open circuit by controlling whether said transistor is in an on or off state.

2. A relay according to claim 1, wherein said field-effect transistor is a MOSFET, and wherein said processor is connected to the gate of said transistor and the source of said transistor is connected to ground.

3. A relay according to claim 1 further comprising an over-current circuit.

4. A relay according to claim 3, wherein said over-current circuit comprises:
a resistor connected to the output of said field-effect transistor; and
an analog to digital converter connected across said resistor for detecting the voltage across said resistor, wherein said converter is further connect to said processor such that said processor may monitor the current through field-effect transistor.

5. A relay according to claim 1 having a housing conforming to ISO standard packaging footprint.

6. A relay according to claim 1 having a housing conforming to 150 series footprints.

7. A mechanical relay system comprising:
a housing having a selected electrical wiring footprint;
a mechanical relay located in said housing; and
a mechanical circuit breaker for operating in conjunction with said relay, wherein said breaker is also located in said housing, such that said relay and breaker are in a packaged unit.

8. A relay system comprising:
a solid state relay implemented in a field-effect transistor; and
a mechanical circuit breaker in electrical communication with said solid state relay for controlling whether the relate is in an on or an off state.

9. A relay system comprising:
a mechanical relay; and
a solid state circuit breaker in electrical communication with said solid state relay for controlling whether the relate is in an on or an off state.

10. A relay according to claim 9, wherein said solid state circuit comprises:
a resistor connected to an output of said relay;
an analog to digital converter connected across said resistor to sense the voltage across said resistor; and
a processor for evaluating the current through said relay by observing the voltage across said resistor.
